(19) United States
(12) Patent Application Publication
(10) Pub. No.: US 2009/0177872 A1
(43) Pub. Date: Jul. 9, 2009

(54) Method and system for generating a valid signal

(76) Inventors: Reinhard Weiberle, Vaihingen/Enz (DE); Bernd Mueller, Gerlingen (DE); Yorck von Collani, Beilstein (DE); Rainer Gmehlich, Ditzingen (DE)

Correspondence Address: KENYON & KENYON LLP, ONE BROADWAY, NEW YORK, NY, 10004, US

(21) Appl. No.: 11/974,349

(22) Filed: Oct. 12, 2007

(30) Foreign Application Priority Data
Oct. 12, 2006 (DE) 10 2006 050 715.0

(51) Int. Cl. G06F 9/30

(52) U.S. Cl. 712/229; 712/E09.016

(57) ABSTRACT

A method for generating a valid signal for an application program in a signal processing system having a plurality of execution units which operate in a performance mode, and in which while the application program is running, a user switches the signal processing system to a comparison mode in which the mode the signals delivered by the execution units are compared with one another to generate the valid signal.

### FIELD OF THE INVENTION

The present invention relates to a method and a system for generating a valid signal for a user program, which runs on a signal processing system having a plurality of execution units that operate in parallel in a performance mode.

### BACKGROUND INFORMATION

In a signal processing system, i.e., a computer system, there is the option in many applications of restarting the application, i.e., the application program, in a safe mode after a error has occurred. In safe mode, the function of the application, i.e., of the application program, may be reduced if necessary. Safe mode is usually activated when a sufficiently serious error has occurred and nevertheless the signal processing system, i.e., computer system, must function at least to a limited extent. Restarting a program application results in a reboot operation, i.e., startup of the operating system. In booting, i.e., starting up a computer, a processor begins at a fixed address to process the BIOS stored in a memory. A test of the connected units is performed and a search is conducted for boot sectors in a configurable sequence.

The first boot sector found is then executed and loads the entire operating system via a boot loader, usually in multiple stages. The operating system then starts a graphic user interface, if necessary, or a command line interpreter. The operating system is booted, i.e., loaded, by execution of the portion of code in the boot sector which is in a memory medium, e.g., a hard disk. This code is generally also referred to as boot code. The boot code retrieves the actual operating system code. In a false start of a boot operation, it is often difficult to determine the cause of this error. After a failed boot operation, the only possibility of restarting the computer system often involves initiating the boot operation from another memory medium, e.g., a floppy disk. For example, if a boot operation for booting the system from the hard drive fails, the user may turn off the computer system and insert a disk into the so-called A drive and attempt to reboot the system from there. With a Windows 95 operating system, there is the possibility of determining, for example, whether there has been a previous failed attempt to boot the operating system. If this happens, i.e., if this is discovered, the Windows 95 operating system will boot in safe mode.

In traditional computer systems, the initialization phase, i.e., boot phase, runs on a microprocessor having a single-core processor architecture. Processors having a dual-core and/or multicore processor architecture are also being used to an increasing extent. Such processors have at least two integrated execution units. These execution units may include a complete microprocessor, i.e., a central processing unit (CPU) or an calculating unit such as a floating point unit (FPU). Alternatively, execution units may also include a digital signal processor (DSP), a coprocessor, or an arithmetic logic unit (ALU).

The dual-core and/or multicore processor architectures having multiple execution units may be operated essentially in two different operating modes. In a first operating mode, known as the performance mode, the various execution units perform different application programs, i.e., tasks. In this performance mode, enhanced performance is thus achieved in comparison with a traditional single-core processor architecture. In contrast with the performance mode, in a comparison mode the execution units perform the same application programs, i.e., tasks, to increase the reliability of the computation result.

In traditional computer systems having dual-core and/or multicore processor architecture, it has not previously been possible to reliably detect hardware defects in the execution units that occur while an application program is running. This may result in serious malfunctions of the operating system, in particular in the case of embedded computer systems, e.g., in the automotive field.

### SUMMARY OF THE INVENTION

Therefore, an object of the exemplary embodiments and/or exemplary methods of the present invention is to create a method for generating a valid signal for an application program in a signal processing system having a plurality of execution units which allow a user to detect errors within the execution units as needed.

The exemplary embodiments and/or exemplary methods of the present invention provides a method for generating a valid signal for an application program in a signal processing system having a plurality of execution units which operate in parallel in a performance mode, wherein after occurrence of an error during the running of the application program, the user switches the signal processing system to a comparison mode in which the signals delivered by the execution units are compared to generate the valid signal.

The method according to the present invention has the advantage that the availability and reliability of application programs that are relevant for the user are significantly increased.

In one specific embodiment of the method according to the present invention, a signal delivered by the execution unit is selected for generating the valid signal.

In a specific embodiment of the method according to the present invention, the signal having the lowest signal deviation from the other signals is selected.

In one specific embodiment of the method according to the present invention, the valid signal is calculated according to a predetermined function on the basis of the signals delivered by the execution units.

In one specific embodiment of the method according to the present invention, the valid signal is formed by the median value of the signals delivered by the execution units.

In one specific embodiment of the method according to the present invention, the signals delivered by the execution units are compared with one another as a function of a configurable comparison operation.

In one specific embodiment of the method according to the present invention, the error is formed by a hardware defect of the signal processing system.

In one specific embodiment of the method according to the present invention, the execution units are formed by identically constructed calculating units or sensors.

In one specific embodiment of the method according to the present invention, the execution units are formed by a floating point unit, a digital signal processor, a CPU, a coprocessor, or an arithmetic logic unit (ALU).

In one specific embodiment of the method according to the present invention, the comparison operation performs a majority decision on the basis of the signals delivered by the execution units.

The present invention also creates a signal processing system for generating a valid signal for an application program having a plurality of execution units which operates in parallel in a performance mode of the signal processing system, the signal processing system being switchable by the user, after the occurrence of an error during the sequence of the application program, from the performance mode to a comparison mode, in which the signals delivered by the execution units are compared with one another to generate the valid signal.

Specific embodiments of the method and system according to the present invention for generating a valid signal for an application program are described below with reference to the accompanying figures to illustrate the features of the present invention.

### BRIEF DESCRIPTION OF THE DRAWINGS

FIG. 1 shows a block diagram depicting possible specific embodiments of the signal processing system according to the present invention for generating a valid signal.

FIG. 2 shows a flow chart of a possible specific embodiment of the method according to the present invention for generating a valid signal for an application program.

### DETAILED DESCRIPTION

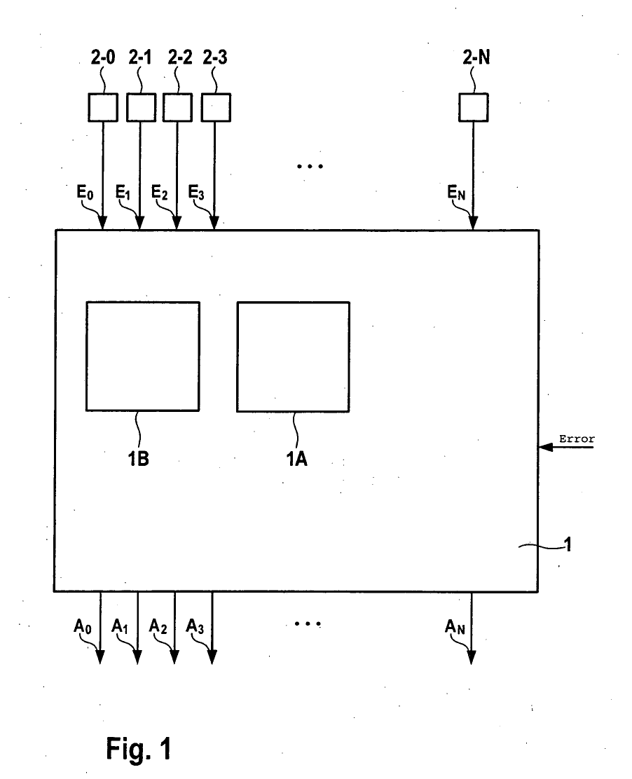

As shown in FIG. 1, the input of a switching and comparison circuit 1 is connected at N+1 execution units 2 and receives logic input signals E₀, E₁, E₂, E₃, . . . , E_{N} from execution units 2-i. Switching and comparison unit 1 includes a comparison logic 1A and a switching logic 1B.

The signal processing system depicted in FIG. 1 may be operated in at least two operating modes. In a first operating mode for enhancing performance, also known as performance mode PM, execution units 2-i, i.e., cores, process different programs, i.e., tasks, in parallel. Execution units 2-i may be any execution units 2-i for executing a computation instruction, e.g., a CPU, a floating point unit FPU, a digital signal processor DSP, a coprocessor, or an arithmetic logic unit ALU. Programs may be processed by various execution units 2-i in performance mode PM may be performed synchronously or, asynchronously. In performance operating mode PM there is no redundant processing but execution units 2-i perform different computations, i.e., programs, in parallel. In strict performance operating mode PM all input signals Eᵢ are switched, i.e., sent separately to corresponding output signals Aᵢ.

In addition to using a high-performance computation system, the second reason for a multicore architecture is to increase the reliability of signal processing by having multiple execution units 2-i process the same program redundantly. In this second operating mode, also known as safe mode or comparison mode VM, the results, i.e., logic output signals of execution units 2-i, are compared with one another by switching and comparison circuit 1, so that an error and/or a signal deviation that has occurred may be detected by comparison for agreement. In strict comparison mode VM, all input signals Eᵢ are therefore directed to, i.e., mapped to, exactly one single output signal Aᵢ. Mixed forms are possible. Configurable switching logic 1B contains the information about how many output terminals, i.e., output signals Aᵢ, are provided. In addition, switching logic 1B contains the information about which input signals Eᵢ contribute to which output signals Aᵢ. A mapping function assigning input signals Eᵢ to different output signals Aᵢ is thus stored in switching logic 1B.

For each output signal Aᵢ, processing logic 1A determines in which form the input signals contribute to the particular output signal. For example, output signal A₀ is generated by input signals E₁, . . . , E_{M}. For m=1, this corresponds simply to patching through one input signal. For m=2, two input signals E₁, E₂ are compared. This comparison may be performed synchronously or asynchronously by circuit 1. The comparison may be performed bit-by-bit or, alternatively, only significant bits are compared with one another. At m≧3 there are various possibilities. In a first possibility, all signals are compared, and if there are at least two different values, an error is detected and optionally signaled by switching and comparison circuit 1. Another possibility is for a K-out-of-m selection to be performed, where K>M/2. In one specific embodiment, this is implemented by providing comparators. A first error signal is optionally generated when one of the input signals is recognized as deviating from the other input signals. If a second error signal is different from the first error signal, all three input signals deviate from one another.

In another specific embodiment, input signal values E are sent to another calculating unit which computes a mean value or a median value, for example, and/or performs an error-tolerant algorithm FTA. In an error-tolerant algorithm, the extreme values of the input signal values are deleted, i.e., ignored, and the remaining signal values are averaged. In one specific embodiment, averaging is performed over the entire set of remaining signal values. In one alternative specific embodiment, averaging is performed over a subset of the remaining signal values that is easily formed in the hardware. While in averaging, only one addition and one division need be performed, FTM, FTA, or the formation of a median value may require sorting of the input signal values. In one specific embodiment, an error signal is optionally output, i.e., displayed, if the signal deviations, i.e., extreme values, are large enough.

The various signal processing options mentioned for forming one signal represent comparison operations. Processing logic 1A defines the precise design of the comparison operation to be performed for each output signal Aᵢ and thus also for input signals Eᵢ. The combination of information within switching logic 1B, i.e., the assignment function of the comparison operation indicated in processing logic 1A per output signal, i.e., per function value, constitutes operating mode information and defines the operating mode. This information usually has multiple values and is represented by more than one logic bit. For the case when only two execution units 2-i are provided and thus there is only one comparison mode, all the information may be condensed into a single logic bit in the operating mode.

The system is generally switched from a performance operating mode PM to a comparison mode VM by the fact that execution units 2-i which are mapped, i.e., patched through, to different signal outputs in performance operating mode PM, are mapped, i.e., patched through, to the same signal output in comparison mode VM. This may be implemented by providing a subset of execution units 2-i in which all input signals Eᵢ which are to be taken into account in the subset are switched directly to corresponding output signals Aᵢ in performance operating mode PM, while in comparison mode VM the input signals are all mapped, i.e., patched through, to a single signal output. Alternatively, switching may be implemented by changing the pairings.

It is possible to switch dynamically between the different operating modes during ongoing operation, controlled by the software. In one specific embodiment, switching is triggered by the execution of special switching commands, i.e., switching instructions, special instruction sequences, explicitly characterized instructions, or by access to certain addresses by at least one of execution units 2-i of the signal processing system.

Switching between safe mode or comparison mode VM, in which redundant processing and checking is performed, and performance operating mode PM, in which performance is enhanced by separate program processing, is performed by switching unit 1. In one specific embodiment, for the purpose of switching, the programs, application programs, program parts, or program commands are characterized by an identifier, which makes it possible to detect whether these program commands must be processed in comparison operating mode VM or whether they may be made accessible to performance operating mode PM. The characterization may take place via one bit in the program command. Alternatively, the subsequent sequence may be characterized by a special program command.

In the safe operating mode, i.e., comparison operating mode VM, the computation of results, i.e., output signals, of execution units 2-i takes place for equal lengths of time in synchronous processing on the different execution units. The results are then available to switching unit 1 in synchronous processing practically simultaneously in safe operating mode VM. If the results match, the corresponding data are enabled. If there is a signal deviation, there is a predetermined error response.

If the signal processing system is in performance operating mode PM, the programs are processed in parallel and comparators, i.e., comparisons, are not triggered within switching and comparison circuit 1.

In the method according to the present invention, a valid signal for an application program in the signal processing system is achieved in multiple execution units 2-i which operate in parallel in performance mode PM by offering the user, after occurrence of an error, in particular a system hardware defect, the opportunity of switching the signal processing system from performance mode PM to a comparison mode VM. In comparison mode VM, the signals delivered by execution units 2 are then compared with one another to generate the valid signal. The signals delivered by execution units 2 may then be selected for generating the valid signal having the least signal deviation from the other signals.

In the case of the system according to the present invention, the signal processing system has the option of switching between performance mode PM and comparison mode VM. Switching from performance mode PM to comparison VM and vice-versa may take place in response to a user request. In one specific embodiment of the method according to the present invention, the valid signal in comparison mode VM is calculated on the basis of the signals delivered by execution units 2 according to a predetermined function, which may be a configurable function. In one possible specific embodiment, the valid signal is formed by the median value of the signals delivered by execution units 2. The signals delivered by execution units 2 may be compared with one another as a function of a configurable comparison operation.

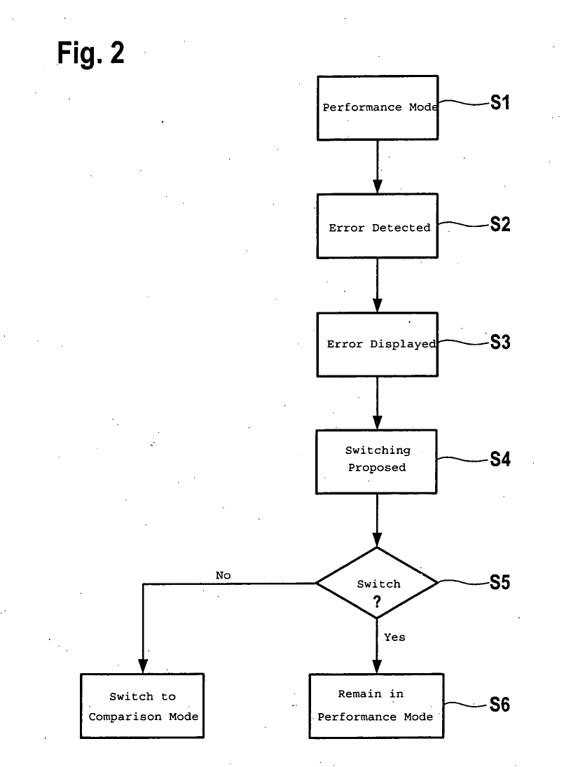

FIG. 2 shows a flow chart of one possible specific embodiment of the method according to the present invention.

In a step S1 an application program runs in a performance operating mode PM.

In another step S2 an error is detected and is signaled to the user in step S3.

In an alternative specific embodiment, steps S2 and S3 are omitted. This is advantageous if the user is to be given an opportunity to have the application selected by him run with the highest possible reliability and robustness. This may be useful in the military field, for example, or in an important presentation, i.e., whenever the reliability of an application is more important than its performance.

In a step S4, the user has an opportunity to switch the signal processing system from performance mode PM into a comparison mode VM in which the signals delivered by the execution units are compared to generate a valid signal. The user thus has an opportunity to switch the hardware of the system in such a way as to allow better error detection and/or error processing.

Step S5 checks on whether the user wishes to perform a switch to comparison mode VM, e.g., within a predetermined period of time. If the user wishes to switch to comparison mode VM, then in step S6 there is a switch from performance mode PM to a comparison mode VM. Subsequently, the application, i.e., the application program, runs in comparison mode VM. If the user does not wish to switch, then there is no switching from performance mode PM to comparison mode VM and the application, i.e., application program, continues to run in the previous performance mode PM.

The method according to the present invention for generating a valid signal is suitable in particular for use in a signal processing system having at least three execution units 2. These at least three execution units 2 are compared with one another by majority voting in comparison mode VM. A majority decision is made here on the basis of the signals delivered by execution units 2. If the signal processing system has three execution units 2, for example, then the three signals delivered by execution units 2 are compared. If there is a signal deviation between the three signals, the signal having the lowest signal deviation from the other signals is selected. For example, if the signals delivered by two execution units are identical and a third signal deviates from the two other signals, then the identical signal is selected as the valid signal and is patched through for further data processing. It is thus possible in this specific embodiment to not only detect hardware defects in execution units 2 but also to perform error processing in a targeted manner.

In another specific embodiment of the method according to the present invention, there is also the possibility for the user to switch the signal processing signal from performance mode PM to comparison mode VM without the occurrence of an error. For example, the user may for certain reasons place a value on a certain portion of the application, i.e., application program, running with the highest possible reliability, availability, safety, and/or access security. Conversely, the user would like to have other parts of the application program run at the highest possible computer performance.

With the method according to the present invention the user is able to switch in a targeted manner between performance mode PM, in which execution units 2 operate in parallel to enhance performance, and comparison mode VM, in which execution units 2 generate a valid signal to enhance security. The user may give a corresponding switch order to the application program.

A typical example is, for example, a transaction within an application program for a bank transfer, which should have the highest possible access security. The particular program commands are performed in comparison mode VM accordingly. As another example, the availability of the application program is optimized in a targeted manner in an important presentation. In another example, the greatest possible security in a critical demonstration phase is achieved in a prototype design by having the application program run in comparison mode VM.

In a first specific embodiment, switching between performance mode PM and comparison mode VM while the application program is running is triggered by the user when the user enters an appropriate switch command.

In an alternative specific embodiment of the method according to the present invention, the corresponding application programs or application program parts are identified in such a way that switching is performed automatically when the identification appears.

In a specific embodiment of the method according to the present invention, the switching is not performed until after the user has received a display of a corresponding error signal, i.e., a system error.

The method according to the present invention is suitable for PC systems as well as embedded systems, e.g., in the automotive field. In a PC environment, the user enters his commands, in particular the switch command, into the computer system via keyboard or mouse. In the case of a cell phone, for example, the keypad is used for inputting the switch command. In the case of a navigation system, switching may be performed by input means provided specifically for this purpose. The method according to the present invention allows the user of the signal processing and/or computer system to utilize the particular properties of DCSL hardware having a switching device between performance mode and comparison mode during operation, so that a particularly high availability and reliability for relevant applications, i.e., application programs, are achieved. In this way, the user is able to increase the availability of an application program in an intentional manner.

What is claimed is:

1. A method for generating a valid signal for an application program in a signal processing system, the method comprising:
operating a plurality of execution units in parallel in a performance mode;
comparing, while the application program is running and after a user switches the signal processing system to a comparison mode, signals delivered by the execution units with one another; and
generating a valid signal based on the comparison.

2. The method of claim 1, wherein the user switches the signal processing system to the comparison mode after an error occurs while the application program is running.

3. The method of claim 1, wherein a signal delivered by the execution units is selected for generating the valid signal.

4. The method of claim 3, wherein a signal having a smallest signal deviation from the other signals is selected.

5. The method of claim 1, wherein the valid signal is determined according to a predetermined function based on signals delivered by the execution units.

6. The method of claim 5, wherein the valid signal is formed by a median value of the signals delivered by the execution units.

7. The method of claim 1, wherein the signals delivered by the execution units are compared with one another as a function of a configurable comparison operation.

8. The method of claim 2, wherein the error is formed by a hardware defect in the signal processing system.

9. The method of claim 1, wherein the execution units are identically constructed calculating units or sensors.

10. The method of claim 9, wherein the execution units include at least one of a floating point unit, a digital signal processor, a processor, a co-processor, and an arithmetic logic unit.

11. The method of claim 7, wherein the comparison operation performs a majority decision based on the signals delivered by the execution units.

12. A signal processing system for generating a valid signal for an application program in a signal processing system, comprising:
a plurality of execution units operable in parallel in a performance mode;
a comparing arrangement to compare, while the application program is running and after a user switches the signal processing system from the performance mode to a comparison mode, signals delivered by the execution units with one another; and
a generating arrangement to generate a valid signal based on the comparison.

13. The signal processing system of claim 12, wherein the signal processing system is switchable by the user while the application program is running after an error occurs.

14. The signal processing system of claim 12, wherein the switching is performed by a switching and comparison circuit.
